(19) United States
(12) Patent Application Publication
(10) Pub. No.: US 2021/0341301 A1
(43) Pub. Date: Nov. 4, 2021

(54) NAVIGATION CONTROL DEVICE, NAVIGATION METHOD, AND NAVIGATION PROGRAM

(71) Applicant: JVCKENWOOD Corporation, Yokohama-shi (JP)

(72) Inventor: Katsuyuki Nagai, Yokohama-shi (JP)

(21) Appl. No.: 17/378,811

(22) Filed: Jul. 19, 2021

Related U.S. Application Data
(63) Continuation of application No. PCT/JP2019/043340, filed on Nov. 5, 2019.

(30) Foreign Application Priority Data
Mar. 25, 2019 (JP) 2019-056031

(51) Int. Cl. G01C 21/34; G06Q 40/08; G01C 21/36

(52) U.S. Cl. CPC G01C 21/3446; G01C 21/3679; G01C 21/3484; G06Q 40/08

(57) ABSTRACT

To prevent a user from passing a section not covered by insurance. A navigation control device includes a map-information acquiring unit that acquires map information, a present-location-information acquiring unit that acquires present location information indicating a position of a present location, an insurance-information acquiring unit that acquires insurance information of an insurance policy taken out by a user, and a section-not-covered-by-insurance-information acquiring unit that acquires, based on the map information acquired by the map-information acquiring unit and the insurance information acquired by the insurance-information acquiring unit, section-not-covered-by-insurance information indicating a section not covered by insurance.

### CROSS-REFERENCE TO RELATED APPLICATION

This application is a Continuation of PCT International Application No. PCT/JP2019/043340 filed on Nov. 5, 2019 which claims the benefit of priority from Japanese Patent Application No. 2019-056031 filed on Mar. 25, 2019, the entire contents of both of which are incorporated herein by reference.

### BACKGROUND

### 1. Technical Field

The present disclosure relates to a navigation control device, a navigation method, and a navigation program.

### 2. Description of the Related Art

There has been known a navigation device that detects a present position of a mobile body, searches for, based on the present position of the mobile body and map information, an optimum route between the present position and a destination set by a user, displays the route on a map, and carries out guidance to the destination. JP 2004-171482 A discloses a technique for calculating insurance premiums of a plurality of routes selected based on a set destination and highlights a route having the lowest insurance premium.

However, J P 2004-171482 A is likely to recommend an insurance contract of a different type every time a present location and a destination change.

### SUMMARY

It is an object of the present disclosure to at least partially solve the problems in the conventional technology.

A navigation control device according to an aspect of the present disclosure includes a map-information acquiring unit that acquires map information, a present-location-information acquiring unit that acquires present location information indicating a position of a present location, an insurance-information acquiring unit that acquires insurance information of an insurance policy taken out by a user, and a section-not-covered-by-insurance-information acquiring unit that acquires, based on the map information acquired by the map-information acquiring unit, the present location information acquired by the present-location-information acquiring unit, and the insurance information acquired by the insurance-information acquiring unit, section-not-covered-by-insurance information indicating a section not covered by insurance.

A navigation method according to an aspect of the present disclosure includes a map-information acquiring step for acquiring map information, a present-location-information acquiring step for acquiring present location information indicating a position of a present location, an insurance-information acquiring step for acquiring insurance information of an insurance policy taken out by a user, and a section-not-covered-by-insurance-information acquiring step for acquiring, based on the map information acquired in the map-information acquiring step, the present location information acquired in the present-location-information acquiring step, and the insurance information acquired in the insurance-information acquiring step, section-not-covered-by-insurance information indicating a section not covered by insurance.

A non-transitory computer readable recording medium storing therein a navigation program according to an aspect of the present disclosure is disclosed. The program causes a computer to execute a map-information acquiring step for acquiring map information, a present-location-information acquiring step for acquiring present location information indicating a position of a present location, an insurance-information acquiring step for acquiring insurance information of an insurance policy taken out by a user, and a section-not-covered-by-insurance-information acquiring step for acquiring, based on the map information acquired in the map-information acquiring step, the present location information acquired in the present-location-information acquiring step, and the insurance information acquired in the insurance-information acquiring step, section-not-covered-by-insurance information indicating a section not covered by insurance.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a block diagram illustrating a configuration example of a navigation device according to an embodiment;

FIG. 2 is a block diagram illustrating a configuration example of a present-location determining unit according to the embodiment;

FIG. 3 is a block diagram illustrating a configuration example of a display control unit according to the embodiment;

FIG. 4 is a block diagram illustrating a configuration example of a notification control unit according to the embodiment;

FIG. 5 is a block diagram illustrating a configuration example of a recording control unit according to the embodiment;

FIG. 6 is a flowchart illustrating an example of processing in the navigation control device according to the embodiment;

FIG. 7 is a flowchart illustrating an example of processing in the navigation control device according to the embodiment; and

FIG. 8 is a flowchart illustrating an example of processing in the navigation control device according to the embodiment.

### DETAILED DESCRIPTION OF THE PREFERRED EMBODIMENTS

An embodiment of a navigation control device and a navigation device is explained in detail below with reference to the drawings. Note that the present disclosure is not limited to the following description of the embodiment. Constituent elements in the embodiment explained below include constituent elements that can be replaced and easily replaced by those skilled in the art and substantially the same constituent elements. Further, various omissions, replacements, or changes of configurations of the constituent elements in the embodiment described below can be performed in a range not departing from the gist of the present disclosure. In the embodiment explained below, constituent elements necessary in illustrating the embodiment of the navigation control device and the navigation device are explained and the other constituent elements are omitted.

In the present disclosure, a navigation device controlled by a navigation control device searches for an optimum route between a present location and a destination set by a user, displays the route on a map, and performs route guidance to the destination. The navigation device retrieves or re-retrieves a route plan to the destination according to content of an insurance policy taken out by the user. The navigation device may be a navigation device for vehicle mounted on a vehicle or a portable navigation device carried into the vehicle or may be a navigation device for pedestrian mounted on a portable terminal. The navigation device may be configured by a portable terminal, a device set in the vehicle, or a combination of several devices.

### Embodiment

Configuration of a Device

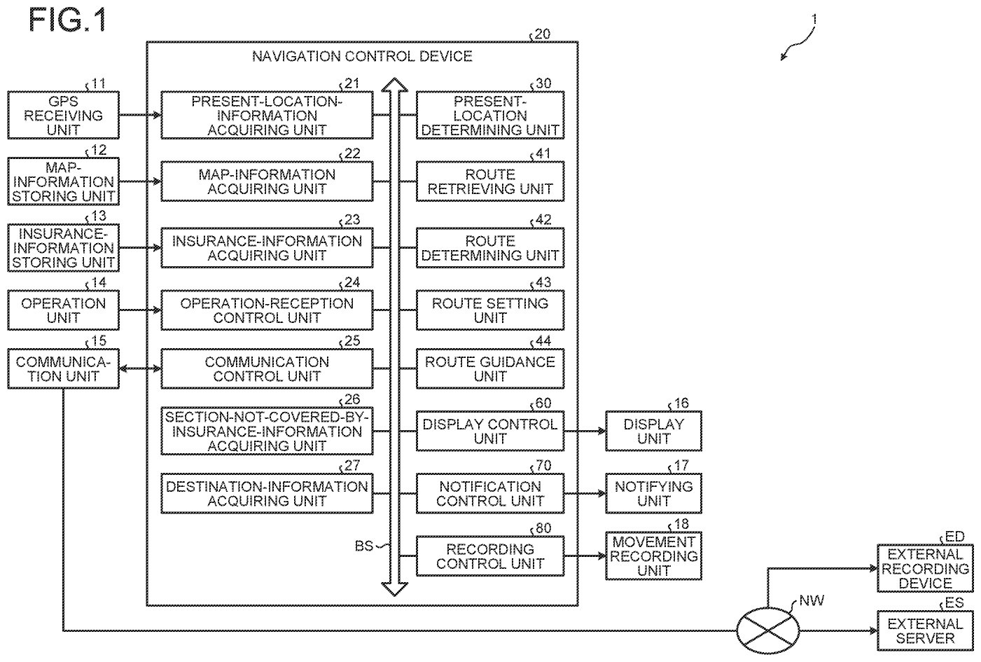

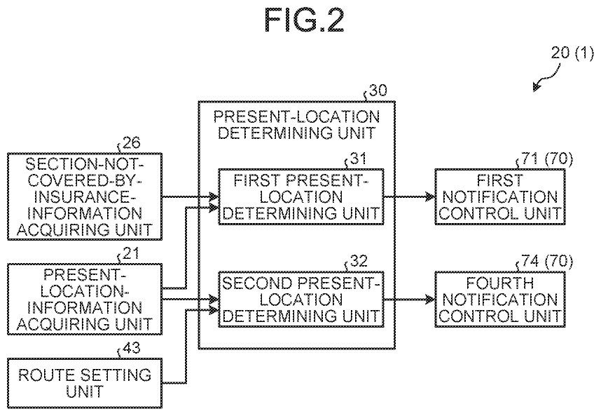

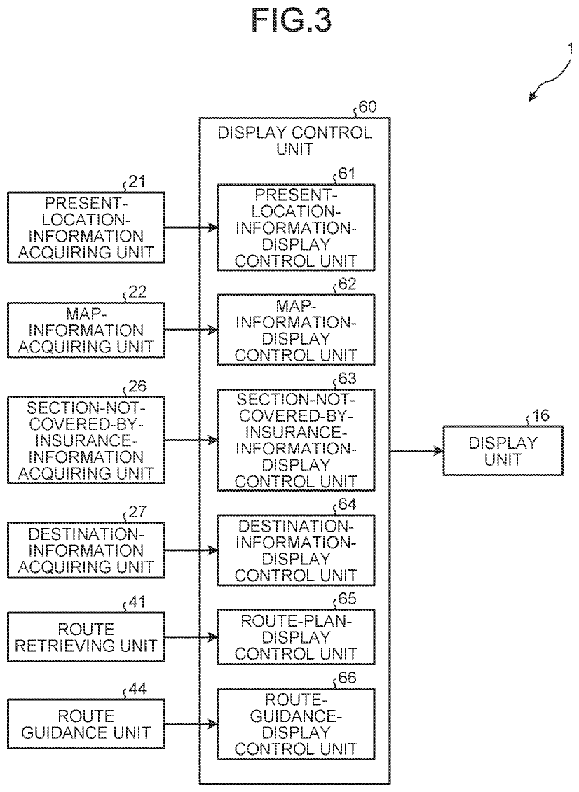

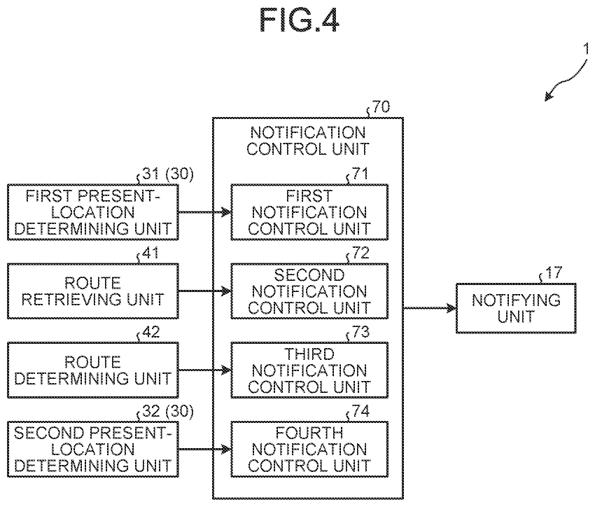

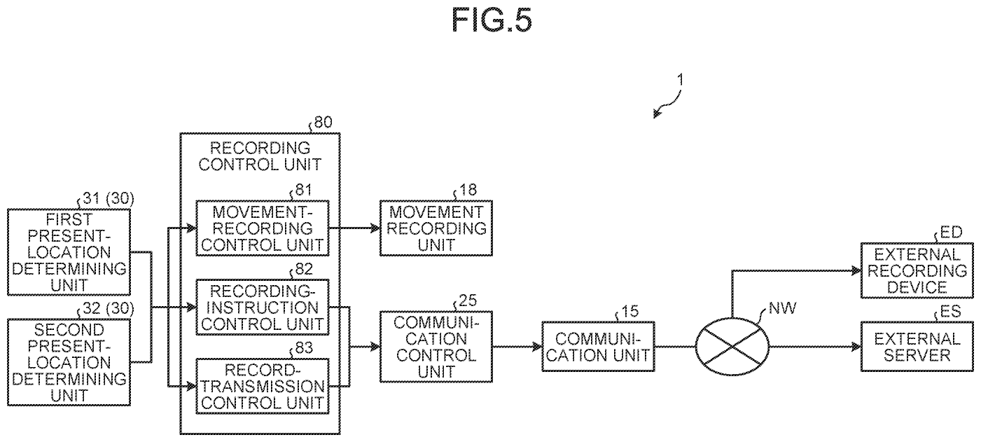

First, an example of the configuration of a navigation device 1 according to an embodiment is explained. FIG. 1 is a block diagram illustrating a configuration example of a navigation device according to the embodiment. FIG. 2 is a block diagram illustrating a configuration example of a present-location determining unit according to the embodiment. FIG. 3 is a block diagram illustrating a configuration example of a display control unit according to the embodiment. FIG. 4 is a block diagram illustrating a configuration example of a notification control unit according to the embodiment. FIG. 5 is a block diagram illustrating a configuration example of a recording control unit according to the embodiment. The navigation device 1 includes a GPS (Global Positioning System) receiving unit 11, a map-information storing unit 12, an insurance-information storing unit 13, an operation unit 14, a communication unit 15, a display unit 16, a notifying unit 17, a movement recording unit 18, and a navigation control device 20.

The GPS receiving unit 11 receives a radio wave from a not-illustrated GPS satellite. The GPS receiving unit 11 outputs a signal of the received radio wave to a present-location-information acquiring unit 21 of the navigation control device 20.

The map-information storing unit 12 stores map information. The map information is, for example, a road map including intersections. The map-information storing unit 12 outputs the stored map information to a map-information acquiring unit 22 of the navigation control device 20. The map-information storing unit 12 may be a storage device such as an external server. When the map-information storing unit 12 is the storage device such as the external server, the map-information storing unit 12 outputs the map information to the map-information acquiring unit 22 via a communication function by a communication control unit 25, the communication unit 15, and the like.

The insurance-information storing unit 13 stores insurance information of an insurance policy taken out by the user. The insurance information is, for example, a type of an insurance and conditions under which the insurance is applied. The type of the insurance includes a general type insurance and an economy type insurance. The general type insurance is an insurance without limitations of conditions under which the insurance is applied such as a traveling route. The economy type insurance is an insurance with limitations of conditions under which the insurance is applied such as a traveling route. The economy type insurance is assumed to be, for example, a personal limited insurance, an objective limited insurance, an insurance not applicable to violation of laws and regulations, an insurance not applicable to natural disasters, a road width limited insurance, a general road limited insurance, and a highway limited insurance. An input of insurance information to the insurance-information storing unit 13 may be performed by the user as initial setting by operating the operation unit 14 or may be associated with an application of a portable terminal. The navigation device 1 may receive, with the communication unit 15, insurance information transmitted from a trader or an insurance company and acquire the insurance information. The acquired insurance information may be manually input to the insurance-information storing unit 13 by the user or may be automatically stored in the insurance-information storing unit 13. The insurance-information storing unit 13 outputs the stored insurance information to an insurance-information acquiring unit 23 of the navigation control device 20. The insurance-information storing unit 13 may include a storage device such as an external server that stores detailed information of the insurance information. When the insurance-information storing unit 13 includes the storage device such as the external server, the insurance-information storing unit 13 outputs the detailed information of the insurance information to the insurance-information acquiring unit 23 via a communication function by the communication control unit 25, the communication unit 15, and the like.

The operation unit 14 is capable of receiving various kinds of operation on the navigation control device 20. The operation unit 14 is configured by physical operation means for the navigation control device 20, a touch panel disposed on the display unit 16, or the like. The operation unit 14 is capable of receiving, for example, operation for inputting insurance information of an insurance policy taken out by the user. The operation unit 14 is capable of receiving, for example, operation for inputting a destination. The operation unit 14 is capable of receiving, for example, operation for determining whether a route plan from a present location to a destination presented by the navigation control device 20 is approved. The operation unit 14 is capable of receiving, for example, operation for starting guidance according to a set route set by approving the route plan. The operation unit 14 outputs operation information to an operation-reception control unit 24 of the navigation control device 20.

The communication unit 15 is a communication unit. The communication unit 15 may perform communication with a method of any one of the Internet, a cellular phone line, and the like. The communication unit 15 executes various kinds of communication based on a control signal output from the communication control unit 25 of the navigation control device 20.

The display unit 16 is, for example, a display device specific to the navigation device 1 or a display device shared by other systems including a car audio. The display unit 16 is, for example, a display including a liquid crystal display (LCD) or an organic EL (Organic Electro-Luminescence) display. In the embodiment, the display unit 16 is a touch panel-type display. The display unit 16 functions as the operation unit 14 and is capable of inputting various kinds of operation. When the navigation device 1 is disposed in a vehicle, the display unit 16 is disposed in a dashboard, an instrument panel, a center console, or the like in front of a driver of a vehicle. The display unit 16 displays, based on a video signal output from a display control unit 60 of the navigation control device 20, a video of route guidance such as a map from a present location to a destination, signs indicating the present location and the destination, and a line indicating the set route.

The notifying unit 17 is configured by, for example, a display disposed on the display unit 16 and a speaker that notifies predetermined notification information with sound. The notifying unit 17 notifies the notification information base on a video signal, a sound signal, and the like output from a notification control unit 70 of the navigation control device 20.

The movement recording unit 18 records a moving route of the vehicle. The movement recording unit 18 executes movement recording for the vehicle based on a control signal output from a movement-recording control unit 81 of a recording control unit 80.

The navigation control device 20 may be implemented as one of functions of a navigation device for vehicle. In the embodiment, the navigation control device 20 is implemented as a function of the navigation device 1 mounted on the vehicle. The navigation control device 20 includes a storage device in which various control programs and data used for various kinds of control processing are stored and an arithmetic processing device that executes a predetermined control program. The storage device is, for example, a nonvolatile or volatile semiconductor memory such as a ROM (Read Only Memory), a RAM (Random Access Memory), a HDD (Hard Disk Drive), or a flash memory, a magnetic disk, a flexible disk, an optical disk, a compact disc, a mini disc, or a DVD. The arithmetic processing device is, for example, a CPU (Central Processing Unit), an MCU (Micro Controller Unit), a microprocessor, a microcomputer, a DSP (Digital Signal Processor), a system LSI (Large Scale Integration). The navigation control device 20 is implemented from one storage device or a plurality of storage devices and one arithmetic processing device or a plurality of arithmetic processing devices.

The navigation control device 20 searches for an optimum route between a present location and a destination set by the user, displays the route on a map of the display unit 16, and performs route guidance to the destination. The navigation control device 20 retrieves or re-retrieves a route plan to the destination according to content of an insurance policy taken out by the user. The navigation control device 20 includes the present-location-information acquiring unit 21, the map-information acquiring unit 22, the insurance-information acquiring unit 23, the operation-reception control unit 24, the communication control unit 25, a section-not-covered-by-insurance-information acquiring unit 26, a destination-information acquiring unit 27, a present-location determining unit 30, a route retrieving unit 41, a route determining unit 42, a route setting unit 43, a route guidance unit 44, the display control unit 60, the notification control unit 70, and the recording control unit 80 connected to a bus BS.

The present-location-information acquiring unit 21 acquires present location information indicating the position of a present location. In the embodiment, the present-location-information acquiring unit 21 acquires present location information of the vehicle based on a signal of a radio wave acquired by the GPS receiving unit 11. The present-location-information acquiring unit 21 outputs the acquired present location information to the map-information acquiring unit 22, a first present-location determining unit 31, a second present-location determining unit 32, and a present-location-information-display control unit 61 of the display control unit 60.

The map-information acquiring unit 22 acquires the map information from the map-information storing unit 12. The map-information acquiring unit 22 acquires, based on a present location of the vehicle acquired by the present-location-information acquiring unit 21 and position information of a destination acquired by the destination-information acquiring unit 27, map information concerning the present location of the vehicle to the destination from the map-information storing unit 12. The map-information acquiring unit 22 outputs the acquired map information to the section-not-covered-by-insurance-information acquiring unit 26, the route retrieving unit 41, and a map-information-display control unit 62 of the display control unit 60.

The insurance-information acquiring unit 23 acquires, from the insurance-information storing unit 13, insurance information of an insurance policy taken out by the user. The insurance-information acquiring unit 23 outputs the acquired insurance information to the section-not-covered-by-insurance-information acquiring unit 26.

The operation-reception control unit 24 acquires operation information of operation received by the operation unit 14. For example, the operation-reception control unit 24 acquires insurance information input operation information indicating input operation for the insurance information of the insurance policy taken out by the user and outputs a control signal. For example, the operation-reception control unit 24 acquires destination input operation information indicating input operation for a destination and outputs a control signal. For example, the operation-reception control unit 24 acquires route plan approval operation information indicating approval operation for a route plan and outputs a control signal. For example, the operation-reception control unit 24 acquires guidance start operation information indicating operation for starting guidance according to a set route and outputs a control signal.

The communication control unit 25 controls communication in the communication unit 15. For example, the communication control unit 25 acquires communication information output from a recording-instruction control unit 82, a record-transmission control unit, or the like of the recording control unit 80. The communication control unit 25 outputs the acquired communication information to the communication unit 15.

The section-not-covered-by-insurance-information acquiring unit 26 acquires section-not-covered-by-insurance information indicating a section not covered by insurance concerning the present location to the destination. The section-not-covered-by-insurance-information acquiring unit 26 acquires the section-not-covered-by-insurance information based on the map information acquired by the map-information acquiring unit 22 and the insurance information acquired by the insurance-information acquiring unit 23. The section-not-covered-by-insurance-information acquiring unit 26 outputs the acquired section-not-covered-by-insurance information to the first present-location determining unit 31, the route retrieving unit 41, and a section-not-covered-by-insurance-information-display control unit 63 of the display control unit 60.

The destination-information acquiring unit 27 acquires, from the operation-reception control unit 24, destination information indicating the position of the destination set by the user with the operation unit 14. The destination-information acquiring unit 27 outputs the acquired destination information to the map-information acquiring unit 22 and a destination-information-display control unit 64 of the display control unit 60.

The present-location determining unit 30 determines a state of the present location based on predetermined conditions. The present-location determining unit 30 includes the first present-location determining unit 31 and the second present-location determining unit 32.

The first present-location determining unit 31 determines, based on the present location of the vehicle acquired by the present-location-information acquiring unit 21 and the section-not-covered-by-insurance information acquired by the section-not-covered-by-insurance-information acquiring unit 26, whether the present location is included in the section not covered by insurance. The first present-location determining unit 31 outputs a determination result to the route retrieving unit 41, a first notification control unit 71 of the notification control unit 70 and the movement-recording control unit 81 and the recording-instruction control unit 82 of the recording control unit 80.

The second present-location determining unit 32 determines, based on the present location of the vehicle acquired by the present-location-information acquiring unit 21 and set route information indicating a set route set by the route setting unit 43, whether the present location is included in the set route. The second present-location determining unit 32 outputs a determination result to the route retrieving unit 41, a fourth notification control unit 74 of the notification control unit 70, and the movement-recording control unit 81 and the recording-instruction control unit 82 of the recording control unit 80.

The route retrieving unit 41 retrieves a route plan from the present location to the destination taking into account the insurance information acquired by the insurance-information acquiring unit 23 and based on preset retrieval conditions. The retrieval conditions may include not passing the section not covered by insurance. The retrieval conditions may include allowing passage in the section not covered by insurance with a preset predetermined distance or predetermined required time set as an upper limit. The route retrieving unit 41 may simultaneously retrieve a plurality of route plans. The route retrieving unit 41 retrieves a route plan based on the map information acquired by the map-information acquiring unit 22 and the section-not-covered-by-insurance information acquired by the section-not-covered-by-insurance-information acquiring unit 26. As a method of retrieving a route plan, a known route retrieving method can be used. The method of retrieving a route plan is not limited. The route retrieving unit 41 outputs route plan information indicating the retrieved route plan to the route determining unit 42, the route setting unit 43, a route-plan-display control unit 65 of the display control unit 60, and a second notification control unit 72 of the notification control unit 70.

When the route determining unit 42 determines that the section not covered by insurance is included in the route plan, the route retrieving unit 41 re-retrieves a route plan from the present location to the destination based on preset re-retrieval conditions. The re-retrieval conditions may include not passing the section not covered by insurance. The re-retrieval conditions may include allowing passage in the section not covered by insurance with a preset predetermined distance or predetermined required time set as an upper limit. The route retrieving unit 41 outputs route plan information indicating the re-retrieved route plan to the route determining unit 42, the route setting unit 43, the route-plan-display control unit 65 of the display control unit 60, and the second notification control unit 72 of the notification control unit 70.

When the second present-location determining unit 32 determines that the present location is not included in the set route and the first present-location determining unit 31 determines that the present location is included in the section not covered by insurance, the route retrieving unit 41 re-retrieves a route plan from the present location to the destination based on preset new route retrieval conditions. The new route retrieval conditions may include returning the vehicle to the set route. The new route retrieval conditions may include passing a shortest route to the section not covered by insurance. The new route retrieval conditions may include allowing passage in the section not covered by insurance with a preset predetermined distance or predetermined required time set as an upper limit. The new route retrieval conditions may include passing a shortest route to the destination. The route retrieving unit 41 outputs route plan information indicating the re-retrieved route plan to the route determining unit 42, the route setting unit 43, and the route-plan-display control unit 65 of the display control unit 60.

When the second present-location determining unit 32 determines that the present location is not included in the set route and the first present-location determining unit 31 determines that the present location is not included in the section not covered by insurance, the route retrieving unit 41 re-retrieves a route plan from the present location to the destination. The route retrieving unit 41 outputs route plan information indicating the retrieved route plan to the route determining unit 42, the route setting unit 43, and the route-plan-display control unit 65 of the display control unit 60.

The route determining unit 42 determines, based on the insurance information acquired by the insurance-information acquiring unit 23, whether the section not covered by insurance is included in the route plan. The route determining unit 42 determines, based on the route plan information indicating the route plan retrieved by the route retrieving unit 41 and the section-not-covered-by-insurance information acquired by the section-not-covered-by-insurance-information acquiring unit 26, whether the section not covered by insurance is included in the route plan. The route determining unit 42 outputs a determination result to the route retrieving unit 41 and a third notification control unit 73 of the notification control unit 70.

The route setting unit 43 sets a set route from the present location to the destination based on a predetermined condition and the route plan information indicating the route plan retrieved by the route retrieving unit 41. The predetermined condition is that, for example, the re-retrieval of a route plan is performed a preset predetermined number of times in the route retrieving unit 41. The predetermined condition is that, for example, predetermined operation for approving a route plan is executed by the operation unit 14. The route setting unit 43 outputs set route information indicating the set route to the second present-location determining unit 32 and the route guidance unit 44.

The route guidance unit 44 performs control to perform guidance of the set route according to the set route information indicating the set route set by the route setting unit 43. As a method of guiding the set route, a known route guidance method can be used. The method of guiding the set route is not limited. The route guidance unit 44 outputs guidance information of the set route to a route-guidance-display control unit 66 of the display control unit 60.

The display control unit 60 performs control to display the set route on the display unit 16 based on the predetermined condition and the acquired display information. The display control unit 60 includes the present-location-information-display control unit 61, the map-information-display control unit 62, the section-not-covered-by-insurance-information-display control unit 63, the destination-information-display control unit 64, the route-plan-display control unit 65, and the route-guidance-display control unit 66.

The present-location-information-display control unit 61 controls, based on the present location information acquired by the present-location-information acquiring unit 21, the display unit 16 to display a sign or the like indicating the present location on the map displayed on the display unit 16.

The map-information-display control unit 62 controls, based on the map information acquired by the map-information acquiring unit 22, the display unit 16 to display a map showing a region including the present location of the vehicle to the destination or a map showing a part of the region.

The section-not-covered-by-insurance-information-display control unit 63 controls, based on the section-not-covered-by-insurance information acquired by the section-not-covered-by-insurance-information acquiring unit 26, the display unit 16 to display a color, a gradation, a sign, or the like indicating the section not covered by insurance on the map displayed on the display unit 16.

The destination-information-display control unit 64 controls, based on the destination information acquired by the destination-information acquiring unit 27, the display unit 16 to display a sign or the like indicating the destination on the map displayed on the display unit 16.

The route-plan-display control unit 65 controls, based on the route plan information indicating the route plan retrieved by the route retrieving unit 41, the display unit 16 to display a line, a sign, or the like indicating the route plan on the map displayed on the display unit 16.

The route-guidance-display control unit 66 controls, based on the guidance information of the set route acquired by the route guidance unit 44, the display unit 16 to display a line, a sign, or the like indicating the set route on the map displayed on the display unit 16.

The notification control unit 70 performs control to notify the notifying unit 17 based on the preset condition and the acquired notification information. The notification control unit 70 includes the first notification control unit 71, the second notification control unit 72, the third notification control unit 73, and the fourth notification control unit 74.

When the first present-location determining unit 31 determines that the present location is included in the section not covered by insurance, the first notification control unit 71 controls the notifying unit 17 to notify the user. For example, the first notification control unit 71 may display warning on the display unit 16 or may warn “enter the section not covered by insurance” by sound.

The second notification control unit 72 controls the notifying unit 17 to notify the user to select whether to approve the route plan retrieved by the route retrieving unit 41. For example, the second notification control unit 72 may display a selection screen on the display unit 16 and may further warn “approve the displayed route?” by sound.

When the route determining unit 42 determines that the section not covered by insurance is included in the route plan, the third notification control unit 73 controls the notifying unit 17 to notify the user. The third notification control unit 73 may control the notifying unit 17 to notify the user to select whether to change the destination. For example, the third notification control unit 73 may display warning on the display unit 16 or may warn “the section not covered by insurance is present in the route” by sound.

When the second present-location determining unit 32 determines that the present location is not included in the set route, the fourth notification control unit 74 controls the notifying unit 17 to notify the user. For example, the fourth notification control unit 74 may display warning on the display unit 16 or may warn “deviating from the set route” by sound.

The recording control unit 80 performs control to perform movement recording for the vehicle based on the predetermined condition and the acquired movement recording information. The recording control unit 80 includes the movement-recording control unit 81, the recording-instruction control unit 82, and a record-transmission control unit 83.

The movement-recording control unit 81 controls the movement recording unit 18 to start recording of a movement record of the vehicle. For example, when the second present-location determining unit 32 determines that the present location is not included in the set route and the first present-location determining unit 31 determines that the present location is included in the section not covered by insurance, the movement-recording control unit 81 controls the movement recording unit 18 to start the recording of the movement record of the vehicle.

The recording-instruction control unit 82 is capable of communicating with an external recording device ED. The external recording device ED is, for example, a drive recorder. The external recording device ED is connected to the navigation device 1 by wire or radio. The external recording device ED may be connected to the navigation device 1 by a communication line NW such as the Internet or a cellular phone line. The recording-instruction control unit 82 performs control to transmit, to the external recording device ED, an instruction for causing the external recording device ED to start the recording of the movement record of the vehicle. When the external recording device ED is a drive recorder, the movement record includes a video record. When the second present-location determining unit 32 determines that the present location is not included in the set route and the first present-location determining unit 31 determines that the present location is included in the section not covered by insurance, the recording-instruction control unit 82 performs control to transmit, to the external recording device ED, an instruction for causing the external recording device ED to start the recording of the movement record. Specifically, the recording-instruction control unit 82 outputs, to the communication control unit 25, communication information including the instruction for causing the external recording device ED to start the recording of the movement record. The communication control unit 25 controls the communication unit 15 to transmit, to the external recording device ED, communication information including the instruction for causing the external recording device ED to start the recording of the movement record.

In the embodiment, the movement-recording control unit 81 and the recording-instruction control unit 82 acquire the movement record in the section not covered by insurance. However, the movement-recording control unit 81 and the recording-instruction control unit 82 may acquire the movement record in a section covered by insurance.

The record-transmission control unit 83 is capable of communicating with an external server ES. The external server ES is, for example, a server owned by an insurance company. The record-transmission control unit 83 performs control to transmit the movement record of the vehicle to the external server ES. Specifically, the record-transmission control unit 83 outputs, to the communication control unit 25, movement record information indicating the movement record of the vehicle recorded by at least one of the movement recording unit 18 and the external recording device ED. The communication control unit 25 controls the communication unit 15 to transmit the movement record information acquired from the record-transmission control unit 83 to the external server ES. The record-transmission control unit 83 may perform control to transmit the movement record information in real time or may perform control to transmit the movement record information according to a request from the insurance company.

Processing by the Device

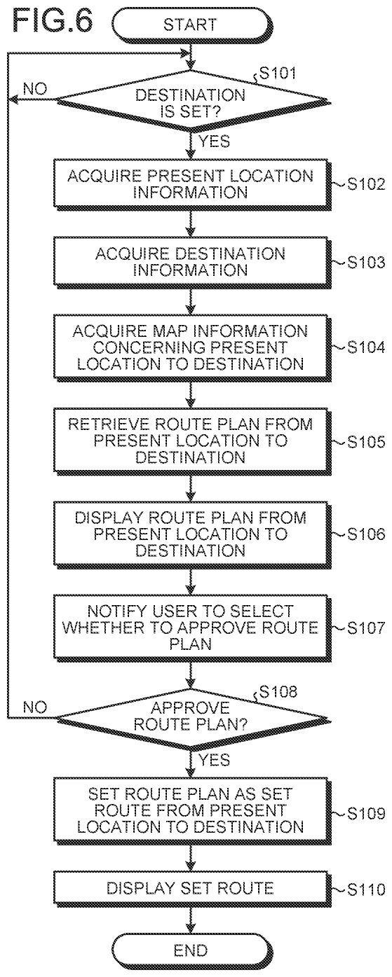

Subsequently, processing of the navigation device 1 until a start of route guidance in the case in which a general type insurance is set is explained with reference to FIG. 6. FIG. 6 is a flowchart illustrating an example of processing in the navigation control device according to the embodiment. The navigation control device 20 executes the processing illustrated in FIG. 6 based on a predetermined control program and data. The user causes the insurance-information storing unit 13 to store, in advance, insurance information of a policy of the general type insurance taken out by the user. The insurance-information storing unit 13 may automatically store insurance information acquired from a trader or an insurance company via the communication unit 15. The user sets retrieval conditions for a route plan in the navigation control device 20 via the operation unit 14 in advance. For example, the user inputs a predetermined start command, whereby the navigation control device 20 shifts to step S101 illustrated in FIG. 6 and starts processing.

The navigation control device 20 determines whether a destination is set (step S101). More specifically, in the navigation control device 20, the operation-reception control unit 24 determines whether operation for setting a destination is executed by the operation unit 14. When the operation-reception control unit 24 does not detect the operation for setting a destination (step S101; No), the navigation control device 20 repeatedly executes step S101 at every predetermined period. When the operation-reception control unit 24 detects the operation for setting a destination (step S101; Yes), the navigation control device 20 shifts to step S102.

When a destination is set (step S101; Yes), the navigation control device 20 acquires present location information (step S102). More specifically, the present-location-information acquiring unit 21 acquires present location information of the vehicle based on a signal of a radio wave acquired by the GPS receiving unit 11. The navigation control device 20 shifts to step S103.

The navigation control device 20 acquires the destination information set in step S101 (step S103). More specifically, the destination-information acquiring unit 27 acquires the destination information acquired by the operation-reception control unit 24. The navigation control device 20 shifts to step S104.

The navigation control device 20 acquires map information from a present location to the destination (step S104). More specifically, the map-information acquiring unit 22 acquires, based on a present location of the vehicle acquired by the present-location-information acquiring unit 21 and position information of the destination acquired by the destination-information acquiring unit 27, map information concerning the present location of the vehicle to the destination from the map-information storing unit 12. The navigation control device 20 shifts to step S105.

The navigation control device 20 retrieves a route plan from the present location to the destination (step S105). More specifically, the route retrieving unit 41 retrieves a route plan based on the map information acquired by the map-information acquiring unit 22. The navigation control device 20 shifts to step S106.

The navigation control device 20 causes the display unit 16 to display the route plan from the present location to the destination (step S106). More specifically, the map-information-display control unit 62 controls the display unit 16 to display a map showing the present location of the vehicle to the destination. The present-location-information-display control unit 61 controls the display unit 16 to display a sign or the like indicating the present location on the map displayed on the display unit 16. The destination-information-display control unit 64 controls the display unit 16 to display a sign or the like indicating the destination on the map displayed on the display unit 16. The route-plan-display control unit 65 controls the display unit 16 to display a line, a sign, or the like indicating the route plan on the map displayed on the display unit 16. The navigation control device 20 shifts to step S107.

The navigation control device 20 notifies the user to select whether to approve the route plan (step S107). More specifically, the second notification control unit 72 controls the notifying unit 17 to notify the user to select whether to approve the route plan. The navigation control device 20 shifts to step S108.

The navigation control device 20 determines whether the user selects to approve the route plan (step S108). More specifically, in the navigation control device 20, the operation-reception control unit 24 determines whether operation for selecting to approve the route plan is executed by the operation unit 14. When the operation-reception control unit 24 detects operation for selecting not to approve the route plan (step S108; No), the navigation control device 20 shifts to step S101. When the operation-reception control unit 24 detects operation for selecting to approve the route plan (step S108; Yes), the navigation control device 20 shifts to step S109.

When the route plan is not approved (step S108; No), the navigation control device 20 checks the setting of the destination in step S101. When the destination is changed, the navigation control device 20 may execute the processing in step S102 to step S108 based on the changed destination and re-retrieve a route plan. When the destination is not changed, the navigation control device 20 may execute the processing in step S102 to step S108 again based on the destination set first and re-retrieve a route plan. In this case, the navigation control device 20 desirably re-retrieves, in step S105, a route plan different from the not-approved route plan. The navigation control device 20 desirably displays, in step S106, the route plan different from the not-approved route plan.

When the route plan is approved (step S108; Yes), the navigation control device 20 sets the route plan as a set route from the present location to the destination (step S109). More specifically, the route setting unit 43 sets a set route from the present location to the destination based on route plan information indicating the route plan retrieved by the route retrieving unit 41. The navigation control device 20 shifts to step S110.

The navigation control device 20 causes the display unit 16 to display the set route (step S110). More specifically, the map-information-display control unit 62 controls the display unit 16 to display a map showing the present location of the vehicle to the destination. The present-location-information-display control unit 61 controls the display unit 16 to display a sign or the like indicating the present location on the map displayed on the display unit 16. The destination-information-display control unit 64 controls the display unit 16 to display a sign or the like indicating the destination on the map displayed on the display unit 16. The route-plan-display control unit 65 controls the display unit 16 to display a line, a sign, or the like indicating the route plan on the map displayed on the display unit 16. The navigation control device 20 ends a series of route setting processing illustrated in FIG. 6. When finishing the processing of the flowchart illustrated in FIG. 6, for example, the navigation control device 20 may automatically start route guidance or may start the route guidance according to an input of a predetermined guidance start command by the user.

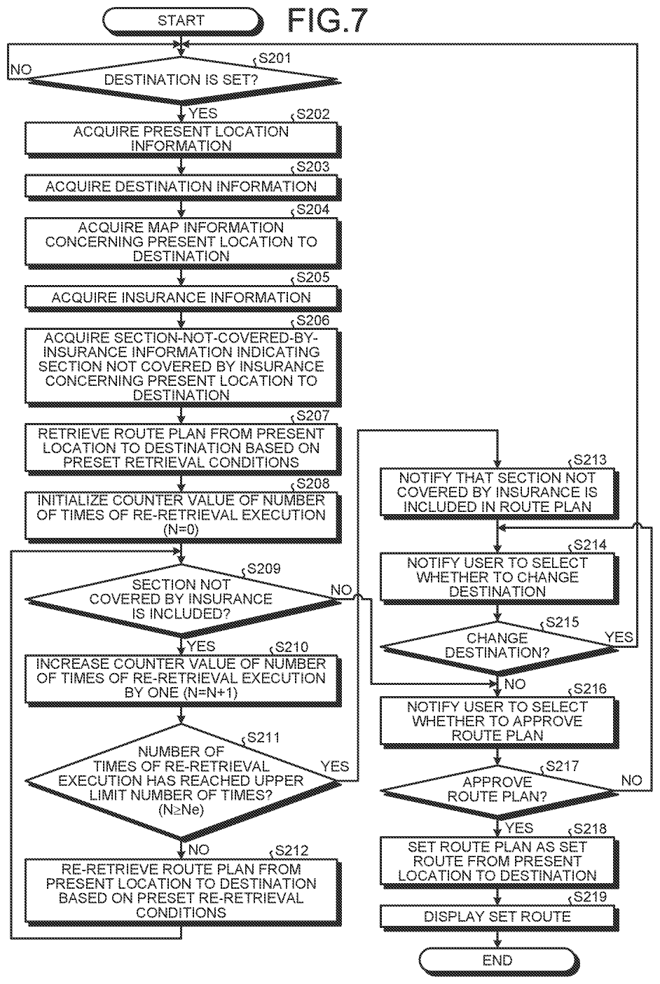

Subsequently, processing of the navigation device 1 until a guidance route from the present location to the destination is set in the case in which an economy type insurance is set is explained with reference to FIG. 7. FIG. 7 is a flowchart illustrating an example of processing in the navigation control device according to the embodiment. The navigation control device 20 executes the processing illustrated in FIG. 7 based on a predetermined control program and data. The user causes the insurance-information storing unit 13 to store, in advance, insurance information of a policy of the economy type insurance taken out by the user. The user sets, in advance, retrieval conditions and re-retrieval conditions for a route plan and an upper limit number of times Ne for executing re-retrieval in the navigation control device 20 via the operation unit 14. The retrieval conditions and the re-retrieval conditions for the route plan and the upper limit number of times Ne for executing the re-retrieval may be set in advance as initial setting. For example, the user inputs a predetermined start command, whereby the navigation control device 20 shifts to step S201 illustrated in FIG. 7 and starts processing.

The navigation control device 20 determines whether a destination is set (step S201). More specifically, in the navigation control device 20, the operation-reception control unit 24 determines whether operation for setting a destination is executed by the operation unit 14. When the operation-reception control unit 24 detects operation for setting a destination (step S201; Yes), the navigation control device 20 shifts to step S202. When the operation-reception control unit 24 does not detect operation for setting a destination (step S201; No), the navigation control device 20 repeatedly executes step S201 at every predetermined period.

When a destination is set (step S201; Yes), the navigation control device 20 acquires present location information (step S202). More specifically, the present-location-information acquiring unit 21 acquires present location information of the vehicle based on a signal of a radio wave acquired by the GPS receiving unit 11. The navigation control device 20 shifts to step S203.

The navigation control device 20 acquires the destination information set in step S201 (step S203). More specifically, the destination-information acquiring unit 27 acquires the destination information acquired by the operation-reception control unit 24. The navigation control device 20 shifts to step S204.

The navigation control device 20 acquires map information concerning the present location to the destination (step S204). More specifically, the map-information acquiring unit 22 acquires, based on a present location of the vehicle acquired by the present-location-information acquiring unit 21 and position information of the destination acquired by the destination-information acquiring unit 27, map information concerning the present location of the vehicle to the destination from the map-information storing unit 12. The navigation control device 20 shifts to step S205.

The navigation control device 20 acquires insurance information (step S205). More specifically, the insurance-information acquiring unit 23 acquires, from the insurance-information storing unit 13, insurance information of an insurance policy taken out by the user. The navigation control device 20 shifts to step S206.

The navigation control device 20 acquires section-not-covered-by-insurance information indicating a section not covered by insurance concerning the present location to the destination (step S206). More specifically, the section-not-covered-by-insurance-information acquiring unit 26 acquires section-not-covered-by-insurance information based on the map information acquired by the map-information acquiring unit 22 and the insurance information acquired by the insurance-information acquiring unit 23. The navigation control device 20 shifts to step S207.

The navigation control device 20 retrieves a route plan from the present location to the destination based on preset retrieval conditions (step S207). More specifically, the route retrieving unit 41 retrieves a route plan based on the map information acquired by the map-information acquiring unit 22 and the section-not-covered-by-insurance information acquired by the section-not-covered-by-insurance-information acquiring unit 26. The navigation control device 20 shifts to step S208.

The navigation control device 20 stores a number of times of re-retrieval execution N, which is a counter value of the number of times of executed re-retrieval, as N=0 (step S208). The navigation control device 20 shifts to step S209.

The navigation control device 20 determines whether the section not covered by insurance is included in the route plan retrieved in step S207 (step S209). More specifically, the route determining unit 42 acquires section-not-covered-by-insurance information indicating the section not covered by insurance concerning the route plan. The route determining unit 42 determines, based on route plan information indicating the route plan retrieved by the route retrieving unit 41 and the section-not-covered-by-insurance information acquired by the section-not-covered-by-insurance-information acquiring unit 26, whether the section not covered by insurance is included in the route plan. When the route determining unit 42 determines that the section not covered by insurance is included in the route plan (step S209; Yes), the navigation control device 20 shifts to step S210. When the route determining unit 42 determines that the section not covered by insurance is not included in the route plan (step S209; No), the navigation control device 20 shifts to step S216.

When the section not covered by insurance is included in the route plan (step S209; Yes), the navigation control device 20 increases the counter value of the number of times of re-retrieval execution N by one and stores the counter value as N=N+1 (step S210). The navigation control device 20 shifts to step S211.

The navigation control device 20 determines whether the number of times of re-retrieval execution N has reached the upper limit number of times Ne (step S211). When determining that the number of times of re-retrieval execution N has not reached the upper limit number of times Ne (step S211; No), the navigation control device 20 shifts to step S212. When determining that the number of times of re-retrieval execution N has reached the upper limit number of times Ne (step S211; Yes), the navigation control device 20 shifts to step S213.

When the number of times of re-retrieval execution N has not reached the upper limit number of times Ne (step S211; No), the navigation control device 20 re-retrieves a route plan from the present location to the destination based on preset re-retrieval conditions (step S212). More specifically, the route retrieving unit 41 re-retrieves a route plan from the present location to the destination based on the preset re-retrieval conditions. The navigation control device 20 shifts to step S209.

When the number of times of re-retrieval execution N has reached the upper limit number of times Ne (step S211; Yes), the navigation control device 20 notifies the user that the section not covered by insurance is included in the route plan (step S213). More specifically, the map-information-display control unit 62 controls the display unit 16 to display a map showing the present location of the vehicle to the destination. The present-location-information-display control unit 61 controls the display unit 16 to display a sign or the like indicating the present location on the map displayed on the display unit 16. The destination-information-display control unit 64 controls the display unit 16 to display a sign or the like indicating the destination on the map displayed on the display unit 16. The route-plan-display control unit 65 controls the display unit 16 to display a line, a sign, or the like indicating the route plan on the map displayed on the display unit 16. The section-not-covered-by-insurance-information-display control unit 63 controls the display unit 16 to display a color, a gradation, a sign, or the like indicating the section not covered by insurance on the map displayed on the display unit 16. The third notification control unit 73 controls the notifying unit 17 to notify the user that the section not covered by insurance is included in the route plan. The navigation control device 20 shifts to step S214.

The navigation control device 20 notifies the user to select whether to change the destination (step S214). More specifically, the third notification control unit 73 controls the notifying unit 17 to notify the user to select whether to change the destination. The navigation control device 20 shifts to step S215.

The navigation control device 20 determines whether the user selects to change the destination (step S215). More specifically, in the navigation control device 20, the operation-reception control unit 24 determines whether operation for selectin to change the destination is executed by the operation unit 14. When the operation-reception control unit 24 detects the operation for selecting to change the destination (step S215; Yes), the navigation control device 20 shifts to step S201. When the operation-reception control unit 24 does not detect the operation for selecting to change the destination (step S215; No), the navigation control device 20 shifts to step S216.

The navigation control device 20 notifies the user to select whether to approve the route plan (step S216). More specifically, the second notification control unit 72 controls the notifying unit 17 to notify the user to select whether to approve the route plan. The navigation control device 20 shifts to step S217.

The navigation control device 20 determines whether the user selects to approve the route plan (step S217). More specifically, in the navigation control device 20, the operation-reception control unit 24 determines whether operation for selecting to approve the route plan is executed by the operation unit 14. When the operation-reception control unit 24 detects operation for selecting not to approve the route plan (step S217; No), the navigation control device 20 shifts to step S214. When the operation-reception control unit 24 detects the operation for selecting to approve the route plan (step S217; Yes), the navigation control device 20 shifts to step S218.

When the route plan is approved (step S217; Yes), the navigation control device 20 sets the route plan as a set route from the present location to the destination (step S218). More specifically, the route setting unit 43 sets a set route from the present location to the destination based on route plan information indicating the route plan retrieved by the route retrieving unit 41. The navigation control device 20 shifts to step S219.

The navigation control device 20 causes the display unit 16 to display the set route (step S219). More specifically, the map-information-display control unit 62 controls the display unit 16 to display a map showing the present location of the vehicle to the destination. The present-location-information-display control unit 61 controls the display unit 16 to display a sign or the like indicating the present location on the map displayed on the display unit 16. The destination-information-display control unit 64 controls the display unit 16 to display a sign or the like indicating the destination on the map displayed on the display unit 16. The route-plan-display control unit 65 controls the display unit 16 to display a line, a sign, or the like indicating the route plan on the map displayed on the display unit 16. The section-not-covered-by-insurance-information-display control unit 63 controls the display unit 16 to display a color, a gradation, a sign, or the like indicating the section not covered by insurance on the map displayed on the display unit 16. The navigation control device 20 ends a series of route setting processing illustrated in FIG. 7. When finishing the processing of the flowchart illustrated in FIG. 7, for example, the navigation control device 20 may automatically start route guidance or may start the route guidance according to an input of a predetermined guidance start command by the user.

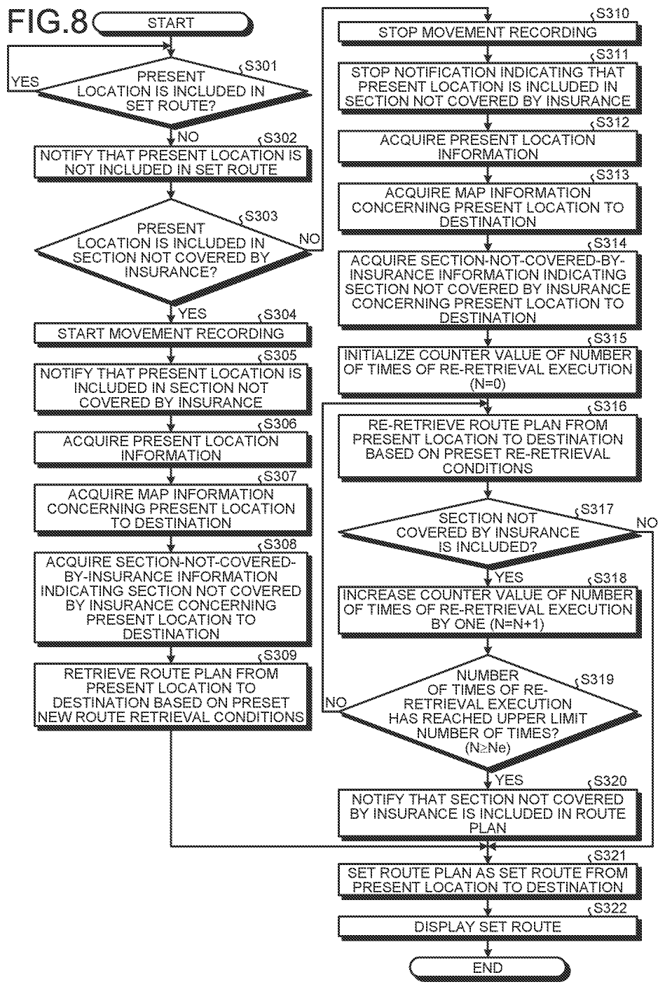

Subsequently, processing of the navigation device 1 during traveling is explained with reference to FIG. 8. FIG. 8 is a flowchart illustrating an example of processing in the navigation control device according to the embodiment. The navigation control device 20 executes the processing illustrated in FIG. 8 based on a predetermined control program and data. For example, the user inputs a predetermined guidance start command, whereby the navigation control device 20 shifts to step S301 illustrated in FIG. 8 and starts the processing. For example, when finishing the processing of the flowchart illustrated in FIG. 7, the navigation control device 20 may automatically shift to step S301 illustrated in FIG. 8 and start the processing. When finishing the processing of the flowchart illustrated in FIG. 8, for example, the navigation control device 20 starts the processing from step S301 at every predetermined period until the user inputs a predetermined end command or reaches a destination.

The navigation control device 20 determines whether a present location is included in a set route (step S301). More specifically, the second present-location determining unit 32 determines, based on the present location of the vehicle acquired by the present-location-information acquiring unit 21 and set route information indicating the set route set by the route setting unit 43, whether the present location is included in the set route. When the second present-location determining unit 32 determines that the present location is included in the set route (step S301; Yes), the navigation control device 20 repeatedly executes step S301 at every predetermined period. When the second present-location determining unit 32 determines that the present location is not included in the set route (step S301; No), the navigation control device 20 shifts to step S302.

When the present location is not included in the set route (step S301; No), the navigation control device 20 notifies the user that the present location is not included in the set route (step S302). More specifically, the fourth notification control unit 74 controls the notifying unit 17 to notify the user that the present location is not included in the set route. The navigation control device 20 shifts to step S303.

The navigation control device 20 determines whether the present location is included in the section not covered by insurance (step S303). More specifically, the navigation control device 20 determines, based on the present location of the vehicle acquired by the present-location-information acquiring unit 21 and the section-not-covered-by-insurance information acquired by the section-not-covered-by-insurance-information acquiring unit 26, whether the present location is included in the section not covered by insurance. When the first present-location determining unit 31 determines that the present location is included in the section not covered by insurance (step S303; Yes), the navigation control device 20 shifts to step S304. When the first present-location determining unit 31 determines that the present location is not included in the section not covered by insurance (step S303; No), the navigation control device 20 shifts to step S310.

When the present location is included in the section not covered by insurance (step S303; Yes), the navigation control device 20 starts recording of a movement record of the vehicle (step S304). More specifically, the movement-recording control unit 81 controls the movement recording unit 18 to start the recording of the movement record of the vehicle. The navigation control device 20 shifts to step S305.

The navigation control device 20 notifies the user that the present location is included in the section not covered by insurance (step S305). More specifically, the first notification control unit 71 controls the notifying unit 17 to notify the user that the present location is included in the section not covered by insurance. The navigation control device 20 shifts to step S306.

The navigation control device 20 acquires present location information (step S306). More specifically, the present-location-information acquiring unit 21 acquires present location information of the vehicle based on a signal of a radio wave acquired by the GPS receiving unit 11. The navigation control device 20 shifts to step S307.

The navigation control device 20 acquires map information concerning the present location to the destination (step S307). More specifically, the map-information acquiring unit 22 acquires, based on the present location of the vehicle acquired by the present-location-information acquiring unit 21 and position information of a set destination, map information concerning the present location of the vehicle to the destination from the map-information storing unit 12. The navigation control device 20 shifts to step S308.

The navigation control device 20 acquires section-not-covered-by-insurance information indicating a section not covered by insurance concerning the present location to the destination (step S308). More specifically, the section-not-covered-by-insurance-information acquiring unit 26 acquires the section-not-covered-by-insurance information based on the map information acquired by the map-information acquiring unit 22 and set insurance information. The navigation control device 20 shifts to step S309.

The navigation control device 20 retrieves a route plan from the present location to the destination based on preset new route retrieval conditions (step S309). More specifically, the route retrieving unit 41 retrieves a route plan based on the map information acquired by the map-information acquiring unit 22 and the section-not-covered-by-insurance information acquired by the section-not-covered-by-insurance-information acquiring unit 26. The navigation control device 20 shifts to step S321.

When the present location is not included in the section not covered by insurance (step S303; No), the navigation control device 20 stops the recording of the movement record of the vehicle (step S310). More specifically, the movement-recording control unit 81 controls the movement recording unit 18 to stop the recording of the movement record of the vehicle. The navigation control device 20 shifts to step S311.

The navigation control device 20 stops notification of notification information indicating that the present location is included in the section not covered by insurance (step S311). More specifically, the first notification control unit 71 controls the notifying unit 17 to stop the notification of the notification information indicating to the user that the present location is included in the section not covered by insurance. The navigation control device 20 shifts to step S312.

The navigation control device 20 acquires present location information (step S312). More specifically, the present-location-information acquiring unit 21 acquires present location information of the vehicle based on a signal of a radio wave acquired by the GPS receiving unit 11. The navigation control device 20 shifts to step S313.

The navigation control device 20 acquires map information concerning the present location to the destination (step S313). More specifically, the map-information acquiring unit 22 acquires, based on the present location of the vehicle acquired by the present-location-information acquiring unit 21 and position information of a set destination, map information concerning the present location of the vehicle to the destination from the map-information storing unit 12. The navigation control device 20 shifts to step S314.

The navigation control device 20 acquires section-not-covered-by-insurance information indicating a section not covered by insurance concerning the present location to the destination (step S314). More specifically, the section-not-covered-by-insurance-information acquiring unit 26 acquires the section-not-covered-by-insurance information based on the map information acquired by the map-information acquiring unit 22 and set insurance information. The navigation control device 20 shifts to step S315.

The navigation control device 20 stores the number of times of re-retrieval execution N, which is a counter value of the number of times of executed re-retrieval, as N=0 (step S315). The navigation control device 20 shifts to step S316.

The navigation control device 20 re-retrieves a route plan from the present location to the destination based on preset re-retrieval conditions (step S316). More specifically, the route retrieving unit 41 re-retrieves a route plan from the present location to the destination based on the preset re-retrieval conditions. The navigation control device 20 shifts to step S317.

The navigation control device 20 determines whether the section not covered by insurance is included in the route plan re-retrieved in step S316 (step S317). More specifically, the route determining unit 42 acquires section-not-covered-by-insurance information indicating the section not covered by insurance concerning the route plan. The route determining unit 42 determines, based on route plan information indicating the route plan re-retrieved by the route retrieving unit 41 and the section-not-covered-by-insurance information acquired by the section-not-covered-by-insurance-information acquiring unit 26, whether the section not covered by insurance is included in the route plan. When the route determining unit 42 determines that the section not covered by insurance is included in the route plan (step S317; Yes), the navigation control device 20 shifts to step S318. When the route determining unit 42 determines that the section not covered by insurance is not included in the route plan (step S317; No), the navigation control device 20 shifts to step S321.

When the section not covered by insurance is included in the route plan (step S317; Yes), the navigation control device 20 increases the counter value of the number of times of re-retrieval execution N by one and stores the counter value as N=N+1 (step S318). The navigation control device 20 shifts to step S319.

The navigation control device 20 determines whether the number of times of re-retrieval execution N has reaches the upper limit number of times Ne (step S319). When determining that the number of times of re-retrieval execution N has not reached the upper limit number of times Ne (step S319; No), the navigation control device 20 shifts to step S316. When determining that the number of times of re-retrieval execution N has reached the upper limit number of times Ne (step S319; Yes), the navigation control device 20 shifts to step S320.

When the number of times of re-retrieval execution N has reached the upper limit number of times Ne (step S319; Yes), the navigation control device 20 notifies the user that the section not covered by insurance is included in the route plan (step S320). More specifically, the third notification control unit 73 controls the notifying unit 17 to notify the user that the section not covered by insurance is included in the route plan. The navigation control device 20 shifts to step S321.

The navigation control device 20 sets the route plan as a set route from the present location to the destination (step S321). More specifically, the route setting unit 43 sets a set route from the present location to the destination based on route plan information indicating the route plan retrieved by the route retrieving unit 41. The navigation control device 20 shifts to step S322.

The navigation control device 20 causes the display unit 16 to display the set route (step S322). More specifically, the map-information-display control unit 62 controls the display unit 16 to display a map showing the present location of the vehicle to the destination. The present-location-information-display control unit 61 controls the display unit 16 to display a sign or the like indicating the present location on the map displayed on the display unit 16. The destination-information-display control unit 64 controls the display unit 16 to display a sign or the like indicating the destination on the map displayed on the display unit 16. The route-plan-display control unit 65 controls the display unit 16 to display a line, a sign, or the like indicating the route plan on the map displayed on the display unit 16. The section-not-covered-by-insurance-information-display control unit 63 controls the display unit 16 to display a color, a gradation, a sign, or the like indicating the section not covered by insurance on the map displayed on the display unit 16. The navigation control device 20 ends a series of route setting processing illustrated in FIG. 8.

As explained above, by setting, in advance, insurance information of an insurance policy taken out by the user, the navigation device 1 can select a route for guiding from the present location to the destination according to the insurance information. Consequently, it is possible to prevent, according to any selection of the user, the user from passing the section not covered by insurance. For example, when the user takes out a policy of an objective limited insurance, a route plan for avoiding routes anticipated to have a high bodily injury occurrence rate such as a busy street, a road without a sidewalk, or a narrow alley or reducing the routes as much as possible is presented. By selecting a route plan for avoiding the section not covered by insurance, it is assumed that insurance money is surely paid when an accident occurs. An insurance company can easily determine whether insurance money should be paid.

The components of the navigation device 1 illustrated in the figures are functionally conceptual components and do not always have to be physically configured as illustrated in the figures. That is, specific forms of the devices are not limited to the specific forms illustrated in the figures. All or a part of the devices may be functionally or physically distributed or integrated in any unit according to processing loads, states of use, and the like of the devices.

The components of the navigation device 1 are realized as, for example, software by a program or the like loaded to a memory. In the embodiment, the components are explained as functional blocks realized by cooperation of the hardware and the software. That is, these functional blocks can be realized in various forms by only the hardware, only the software, or a combination of the hardware and the software.

According to the present disclosure, there is an effect that it is possible prevent a user from passing a section not covered by insurance.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A navigation control device comprising:
a map-information acquiring unit that acquires map information;
a present-location-information acquiring unit that acquires present location information indicating a position of a present location;
an insurance-information acquiring unit that acquires insurance information of an insurance policy taken out by a user; and
a section-not-covered-by-insurance-information acquiring unit that acquires, based on the map information acquired by the map-information acquiring unit, the present location information acquired by the present-location-information acquiring unit, and the insurance information acquired by the insurance-information acquiring unit, section-not-covered-by-insurance information indicating a section not covered by insurance.

2. The navigation control device according to claim 1, further comprising:
a destination-information acquiring unit that acquires destination information indicating a position of a destination set by the user; and
a route retrieving unit that retrieves a route plan from the present location to the destination taking into account the insurance information.

3. The navigation control device according to claim 2, further comprising
a route determining unit that determines, based on the insurance information, whether the section not covered by insurance is included in the route plan, wherein
when the section not covered by insurance is included in the route plan, the route retrieving unit re-retrieves a route plan from the present location to the destination based on preset re-retrieval conditions.

4. The navigation control device according to claim 2, further comprising
a route setting unit that, when predetermined operation for approving the route plan is executed, sets a set route from the present location to the destination based on the route plan.

5. The navigation control device according to claim 4, wherein,
when the present location is not included in the set route and when the present location is included in the section not covered by insurance, the route retrieving unit re-retrieves a route plan from the present location to the destination based on preset new route retrieval conditions.

6. The navigation control device according to claim 4, further comprising
a movement-recording control unit that, when the present location of a passing user is not included in the set route and when the present location is included in the section not covered by insurance, performs control to start recording of a movement record.

7. The navigation control device according to claim 6, further comprising
a record-transmission control unit that is capable of communicating with an external server and performs control to transmit the movement record to the external server.

8. The navigation control device according to claim 4, wherein,
when a present location of a passing user is not included in the set route and when the present location is not included in the section not covered by insurance, the route retrieving unit re-retrieves a route plan from the present location to the destination.

9. A navigation method comprising:
a map-information acquiring step for acquiring map information;
a present-location-information acquiring step for acquiring present location information indicating a position of a present location;
an insurance-information acquiring step for acquiring insurance information of an insurance policy taken out by a user; and
a section-not-covered-by-insurance-information acquiring step for acquiring, based on the map information acquired in the map-information acquiring step, the present location information acquired in the present-location-information acquiring step, and the insurance information acquired in the insurance-information acquiring step, section-not-covered-by-insurance information indicating a section not covered by insurance.

10. A non-transitory computer readable recording medium storing therein a navigation program for causing a computer to execute:
a map-information acquiring step for acquiring map information;
a present-location-information acquiring step for acquiring present location information indicating a position of a present location;
an insurance-information acquiring step for acquiring insurance information of an insurance policy taken out by a user; and
a section-not-covered-by-insurance-information acquiring step for acquiring, based on the map information acquired in the map-information acquiring step, the present location information acquired in the present-location-information acquiring step, and the insurance information acquired in the insurance-information acquiring step, section-not-covered-by-insurance information indicating a section not covered by insurance.
